(19) United States
(12) Patent Application Publication
(10) Pub. No.: US 2026/0244223 A1
(43) Pub. Date: Aug. 20, 2026

(54) INFORMATION PROCESSING APPARATUS, CONTROL APPARATUS, CONTROL METHOD, AND COMPUTER-READABLE RECORDING MEDIUM

(71) Applicant: NEC Corporation, Tokyo (JP)

(72) Inventor: Manao MACHIDA, Tokyo (JP)

(73) Assignee: NEC Corporation, Tokyo (JP)

(21) Appl. No.: 19/160,490

(22) PCT Filed: Mar. 1, 2023
(86) PCT No.: PCT/JP2023/007603

§ 371 Date: Aug. 28, 2025

(51) Int. Cl. G05D 1/695; G05B 15/02; G05D 1/617

(52) U.S. Cl. CPC G05D 1/695; G05B 15/02; G05D 1/617

(57) ABSTRACT

An information processing device includes: a route setting unit that sets routes for respective mobile bodies of a formation that performs leader-follower control; a virtual barrier setting unit that sets virtual barriers for mobile bodies; a sensing unit that calculates a position of a follower mobile body that is recognized by a leader mobile body; a communication unit that transmits and receives the routes and the virtual barriers, or further transmits and receives the positions of the mobile bodies, in response to a request; a route storage unit; a virtual barrier storage unit; a self-recognized position maximum deviation prediction unit that predicts a maximum value of a deviation between a self-recognized position and an actual position; and a self-position recognition unit that estimates the self-recognized position, and, when it has been determined the mobile bodies may be outside of the virtual barriers, requests communication and updates the self-recognized position.

### TECHNICAL FIELD

The present disclosure relates to an information processing apparatus, a control apparatus, and a control method for planning a path when a plurality of mobile bodies moves in cooperation, and further relates to a computer-readable recording medium recording a program for achieving the information processing apparatus, the control apparatus, and the control method.

### BACKGROUND ART

A control method in which mobile bodies serving as a small number of leaders (hereinafter, referred to as “leader mobile bodies” or “leaders”) make mobile bodies serving as a large number of followers (hereinafter, referred to as “follower mobile bodies” or “followers”) follow is referred to as leader-follower control. The mobile body is, for example, a robot.

An advantage of the leader-follower control is that when the small number of leaders have high performance, even when the large number of the followers have low performance, the followers can compensate for the low performance by taking actions in response to instructions from the leaders. By using this mechanism, it is not necessary to make all the mobile bodies high performance, but it is sufficient to make only a part of the mobile bodies high performance, and therefore, cost reduction and the like can be achieved.

NPL 1 proposes a method in which only a leader grasp a path and moves along the path and followers move in such a way as to maintain relative positions with the leader, and thus a formation is formed and movement is performed.

NPL 2 proposes a method of determining only a path of a leader and generating paths of followers (paths for the followers to move in a formation with the leader) from the path of the leader.

### CITATION LIST

### Non Patent Literature

NPL 1: Takashi Ikeda, and three others, Formation Control of Multiple Nonholonomic Mobile Robots, The transactions of the Institute of Electrical Engineers of Japan. D (A publication of Industry Applications Society), 2004, Vol. 124, No. 8, p. 814-819
NPL 2: Suzuki Manabu, and four others, Leader-following Formation Navigation with Virtual Trajectories for Dynamic Multi-agents, Journal of the Japan Society for System Control and Information, 2016, Vol. 29, No. 8, p. 382-389

### SUMMARY OF INVENTION

### Technical Problem

For example, in a case where a mobile body moves for a long distance, functions of detecting an obstacle such as an infrared sensor or a GPS and measuring a self-position are indispensable. In the leader-follower control, only the mobile bodies serving as the leaders have these functions, and determine necessity of avoiding an obstacle or confirm self-positions to measure differences from a path. The leaders instruct future actions such as avoidance to the followers by using communication devices. The followers can avoid the obstacle without the detection function by performing avoidance according to the instructions of the leaders.

Here, the method proposed in NPL 1 has a problem that the followers have to perform sensing or communication at a high frequency in order to know a position of the leader. In particular, in the sea where acoustic sensing and acoustic communication are required, costs (power consumption and the like) of the sensing and the communication are high.

An example of an object of the present disclosure is to provide an apparatus that reduces a frequency of communication while maintaining safety of a mobile body.

### Solution to Problem

In order to achieve the above object, an information processing apparatus in one aspect of the present disclosure includes
a path setting means for setting a path of each mobile body in a formation controlled in such a way that a leader mobile body makes a follower mobile body follow,
a virtual barrier setting means for setting virtual barriers indicating safe regions of the mobile bodies,
a sensing means for measuring relative coordinates with the another mobile body and calculating a position of the follower mobile body recognized by the leader mobile body,
a communication means for transmitting and receiving, according to a request, the paths and the virtual barriers, or further positions of the mobile bodies,
a path storage means for storing the set paths,
a virtual barrier storage means for storing the set virtual barriers,
a self-recognition position maximum displacement prediction means for predicting a maximum value of displacement between a self-recognition position and an actual position, and
a self-position recognition means for estimating the self-recognition position, requesting communication in a case where it is determined that there is a possibility that the mobile body is outside the virtual barrier in consideration of the maximum value of the displacement, and updating the self-recognition position.

In order to achieve the above object, a control method by a computer in one aspect of the present disclosure includes
setting a path of each mobile body in a formation controlled in such a way that a leader mobile body makes a follower mobile body follow,
setting virtual barriers indicating safe regions of the mobile bodies,
measuring relative coordinates with the another mobile body and calculating a position of the follower mobile body recognized by the leader mobile body,
transmitting and receiving, according to a request, the paths and the virtual barriers, or further positions of the mobile bodies,
storing the set paths,
storing the set virtual barriers,
predicting a maximum value of displacement between a self-recognition position and an actual position, and
estimating the self-recognition position, requesting communication in a case where it is determined that there is a possibility that the mobile body is outside the virtual barrier in consideration of the maximum value of the displacement, and updating the self-recognition position.

In order to achieve the above object, a computer-readable recording medium in one aspect of the present disclosure causes a computer to
set a path of each mobile body in a formation controlled in such a way that a leader mobile body makes a follower mobile body follow,
set virtual barriers indicating safe regions of the mobile bodies,
measure relative coordinates with the another mobile body and calculate a position of the follower mobile body recognized by the leader mobile body,
transmit and receive, according to a request, the paths and the virtual barriers, or further positions of the mobile bodies,
store the set paths,
store the set virtual barriers,
predict a maximum value of displacement between a self-recognition position and an actual position, and
estimate the self-recognition position, request communication in a case where it is determined that there is a possibility that the mobile body is outside the virtual barrier in consideration of the maximum value of the displacement, and update the self-recognition position.

### Advantageous Effects of Invention

As described above, according to the present disclosure, it is possible to reduce a frequency of communication while maintaining safety of a mobile body.

### BRIEF DESCRIPTION OF DRAWINGS

FIG. 1 is a diagram for describing an example of an information processing apparatus in a first example embodiment.

FIG. 2 is a system diagram for more specifically describing an example of the information processing apparatus in the first example embodiment.

FIG. 3 is a diagram for describing an example of processing (initial setting) in the information processing apparatus in the first example embodiment.

FIG. 4 is a diagram for describing an example of processing (in a case where a follower goes out of a virtual barrier) in the information processing apparatus in the first example embodiment.

FIG. 5 is a diagram for describing an example of processing (in a case where a leader goes out of the virtual barrier) in the information processing apparatus in the first example embodiment.

FIG. 6 is a diagram for describing an example of processing (entire processing) in the information processing apparatus in the first example embodiment.

FIG. 7 is a diagram for describing an example of paths of the leader and the followers in a first example.

FIG. 8 is a diagram for describing an example of the virtual barriers of the leader and the followers in the first example.

FIG. 9 is a diagram for describing an example of the virtual barrier for communication maintenance in the first example.

FIG. 10 is a diagram for describing an example of positions of the leader and the followers in the virtual barrier for communication maintenance in the first example.

FIG. 11 is a diagram for describing an example of a relationship between the virtual barrier of a mobile body and positional displacement in the first example.

FIG. 12 is a diagram for describing an example of a relationship between a self-recognition position and an actual position of the mobile body in the first example.

FIG. 13 is a diagram for describing an example of the virtual barriers for collision prevention and the virtual barrier for communication maintenance of the leader and the followers in the first example.

FIG. 14 is a diagram for describing an example of a case where the follower goes out of the virtual barrier in the first example.

FIG. 15 is a diagram for describing an example of a computer that achieves the first example embodiment and the first example.

### EXAMPLE EMBODIMENT

### First Example Embodiment

Hereinafter, an example embodiment will be described with reference to the drawings. In the drawings described below, elements having the same function or related functions are denoted by the same reference signs, and repeated description thereof may be omitted.

### [Apparatus Configuration]

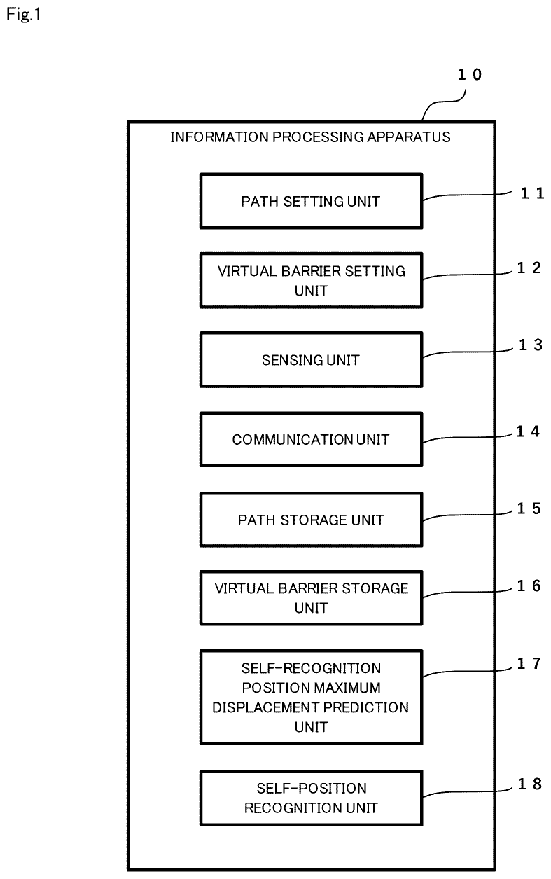

FIG. 1 is a diagram for describing an example of an information processing apparatus in a first example embodiment. As illustrated in FIG. 1, an information processing apparatus 10 includes a path setting unit 11, a virtual barrier setting unit 12, a sensing unit 13, a communication unit 14, a path storage unit 15, a virtual barrier storage unit 16, a self-recognition position maximum displacement prediction unit 17, and a self-position recognition unit 18.

The path setting unit 11 sets a path of each mobile body in a formation controlled in such a way that a leader mobile body makes a follower mobile body follow. The path setting unit 11 functions as path setting means. The path setting unit 11 is a device provided in a leader mobile body 20, and sets paths of the leader mobile body 20 and each follower mobile body 21. It is sufficient that the path of the leader mobile body 20 is set by an optional method, and the paths of the follower mobile bodies are generated from the path of the leader mobile body 20 and desired relative coordinates of the follower mobile bodies 21 using, for example, the method described in NPL 2.

Here, it is assumed that the path of the leader mobile body is given by, for example, a function P as in the following expression.

$$P ( t ) = p$$

Here, an argument t is a time, and the above expression represents that the leader mobile body should be at coordinates p at the time t. The function P takes the optional time t as the argument and returns the coordinates p at which the leader mobile body should be at the time t, to represent the path.

The virtual barrier setting unit 12 sets virtual barriers 30 and 31 indicating safe regions of the mobile bodies 20 and 21. The virtual barrier setting unit 12 functions as virtual barrier setting means. The virtual barrier setting unit 12 is a device provided in the leader mobile body 20, and sets the virtual barriers representing boundaries between safe regions (regions where collision can be avoided) and a dangerous region. Similarly to the paths, the virtual barriers 30 and 31 are set for the leader mobile body 20 and each follower mobile body 21, and a plurality of virtual barriers may be set for one mobile body.

The virtual barriers 30 and 31 are determined based on the paths. For example, each of the virtual barriers 30 and 31 is given in a form of a sphere with a radius r centered on a point at which the mobile body should be on the path at each time. That is, based on the function P(t) related to the path, the virtual barriers 30 and 31 at the time t are the spheres each having the radius r centered on the coordinates p.

That is, the virtual barriers 30 and 31 move along the paths over time. In other words, the fact that the mobile bodies 20 and 21 are outside their own virtual barriers 30 and 31 at a certain time indicates that the mobile bodies 20 and 21 are separated from positions where they should be on the paths at that time by equal to or more than a certain distance.

First, in order to prevent collision between the mobile bodies 20 and 21, the virtual barrier setting unit 12 sets the virtual barriers (also referred to as virtual barriers for collision avoidance) 30 and 31 in such a way that the virtual barriers 30 and 31 do not have a common region with each other at an optional time, that is, the collision can be avoided. Since there is no common region, the mobile bodies 20 and 21 do not collide with the other mobile bodies 20 and 21 as long as they are in the virtual barriers 30 and 31.

Next, in order to maintain communication between the leader mobile body 20 and the follower mobile bodies 21, the virtual barrier setting unit 12 sets a virtual barrier for communication maintenance 32 in such a way that a maximum distance between the virtual barrier 30 of the leader mobile body 20 and the virtual barriers 31 of the follower mobile bodies 21 at an optional time is equal to or less than a communication distance.

Since the maximum distance of the virtual barrier for communication maintenance 32 is equal to or less than the communication distance, the communication between the leader and the followers is maintained as long as the mobile bodies 20 and 21 are in the virtual barrier 32.

The virtual barriers for collision avoidance 30 and 31 may be covered with the virtual barrier for communication maintenance 32. In such a case, the mobile bodies do not go out of the virtual barrier for communication maintenance 32 unless the mobile bodies go out of the virtual barriers for collision avoidance 30 and 31, and therefore, it is sufficient that only the virtual barriers for collision avoidance 30 and 31 are set as the virtual barriers.

The sensing unit 13 measures relative coordinates with other mobile bodies 21, and calculates positions of the follower mobile bodies 21 recognized by the leader mobile body 20. The sensing unit 13 functions as sensing means.

The sensing unit 13 is a device provided in the leader mobile body 20, and measures relative coordinates of the leader mobile body 20 and the other follower mobile bodies 21. By adding the measured relative coordinates to a self-recognition position of the leader mobile body 20, the positions (coordinates) of the follower mobile bodies 21 estimated by the leader mobile body 20 are calculated. The calculated positions of the follower mobile bodies 21 are transmitted to the communication unit 14 and further transmitted to the follower mobile bodies 21. The sensing unit 13 may also be referred to as a “sensor”. The sensor measures the positions of the follower mobile bodies 21. For convenience of description, processing will be described using the positions obtained by adding the relative positions (coordinates) and the self-recognition position, but similar processing can be achieved even with the relative positions, and therefore, processing as described later may be achieved using the positions measured by the sensor.

The communication unit 14 transmits and receives the paths and the virtual barriers 30 and 31, or further the positions of the mobile bodies 20 and 21 according to a request. The communication unit 14 functions as communication means.

The communication unit 14 is a device provided in each of the leader mobile body 20 and the follower mobile bodies 21, and transmits and receives information between the mobile bodies 20 and 21.

A communication unit 14a of the leader mobile body 20 transmits the path of each follower mobile body 21 generated by the path setting unit 11 to each follower mobile body 21. The virtual barrier 31 of each follower mobile body 21 generated by the virtual barrier setting unit 12 is then transmitted to each follower mobile body 21.

A communication timing other than the above communication timing is a timing at which any one of the mobile bodies 20 and 21 tries to break its own virtual barrier 30 or 31. As will be described in detail later, safety is maintained as long as the mobile bodies 20 and 21 are in the virtual barriers 30 and 31, and thus the mobile bodies 20 and 21 do not need to perform communication. On the other hand, when any one of the mobile bodies 20 and 21 goes out (or is about to go out) of the virtual barrier 30 or 31, there is a risk of collision or communication failure between the mobile bodies, and thus communication is performed.

The path storage unit 15 stores the set paths. The path storage unit 15 functions as path storage means.

The path storage unit 15 is a device provided in each of the leader mobile body 20 and the follower mobile bodies 21, and receives and stores the paths set by the path setting unit 11.

The virtual barrier storage unit 16 stores the set virtual barriers 30 and 31. The virtual barrier storage unit 16 functions as virtual barrier storage means.

The virtual barrier storage unit 16 is a device provided in each of the leader mobile body 20 and the follower mobile bodies 21, and receives and stores the virtual barriers 30 and 31 set by the virtual barrier setting unit 12.

The self-recognition position maximum displacement prediction unit 17 predicts a maximum value of displacement between a self-recognition position and an actual position. The self-recognition position maximum displacement prediction unit 17 functions as self-recognition position maximum displacement prediction means.

The self-recognition position maximum displacement prediction unit 17 is a device provided in each of the leader mobile body 20 and the follower mobile bodies 21, and predicts a maximum value of displacement between a self-recognition position and an actual self-position of each of the mobile bodies 20 and 21. For example, in a case where the mobile bodies 20 and 21 are vehicles, their own movement distances are predicted from rotational frequencies of tires and the like, and self-positions are predicted by superimposing the movement distances. The self-positions recognized by the mobile bodies 20 and 21 are referred to as the self-recognition positions.

The self-recognition position naturally has the displacement from the actual self-position. In the example of the vehicle, an actual movement distance is displaced from the predicted movement distance due to tire slip or the like. This displacement becomes a difference between the self-recognition position and the actual self-position. In general, the self-recognition position and the actual self-position tend to increase as time elapses. The self-recognition position maximum displacement prediction unit 17 predicts the maximum value of the displacement between the self-recognition position and the actual self-position at each time.

A device that estimates the self-position is mounted on each of the mobile bodies 20 and 21 that autonomously move, and an error per unit time is often displayed as a specification on the device. This is expressed as, for example, within 10 m per hour. This means that an amount of increase in the displacement (distance) between the self-recognition position and the actual self-position in one hour is 10 m at the maximum.

The self-recognition position maximum displacement prediction unit 17 may simply predict the maximum displacement at each time based on this specification. That is, in the above example, the maximum value of the displacement in one hour can be set to 10 m, and the maximum value of the displacement in two hours can be set to 20 m.

The self-position recognition unit 18 estimates the self-recognition position, and in a case where it is determined that there is a possibility that the mobile bodies 20 and 21 are outside the virtual barriers 30 and 31 in consideration of the maximum value of the displacement predicted by the self-recognition position maximum displacement prediction unit 17, requests communication and updates the self-recognition position. The self-position recognition unit 18 functions as self-position recognition means.

The self-position recognition unit 18 is a device provided in each of the mobile bodies 20 and 21, and estimates the self-position of each of the mobile bodies 20 and 21. Many mobile bodies that move autonomously include this device.

The self-position recognition unit 18 in the present disclosure has a function of determining whether there is a possibility that the mobile bodies 20 and 21 are outside the virtual barriers 30 and 31, in addition to the above function. At this time, not only whether the self-recognition positions of the mobile bodies 20 and 21 are simply outside the virtual barriers 30 and 31, but also whether the mobile bodies will go out in the future when they continue to move is determined. This is what is meant by “determining whether there is a possibility”.

For example, there is a margin of 5 m to the outside of the virtual barriers 30 and 31 at the self-recognition positions of the mobile bodies 20 and 21, but when the predicted maximum displacement is 6 m, there is a possibility that the mobile bodies 20 and 21 are outside the virtual barriers 30 and 31 at the actual self-positions. Therefore, in such a case, the self-position recognition unit 18 determines that there is a possibility that the mobile bodies 20 and 21 are outside the virtual barriers 30 and 31.

In a case where it is determined that there is a possibility that the mobile bodies 20 and 21 are outside the virtual barriers 30 and 31 (that is, the mobile bodies 20 and 21 go out of the virtual barriers 30 and 31), there are risks of collision or communication interruption between the mobile bodies 20 and 21. In this case, the self-position recognition unit 18 requests the communication unit 14 to perform communication between the mobile bodies 20 and 21, and avoids these risks by the communication.

### [System Configuration]

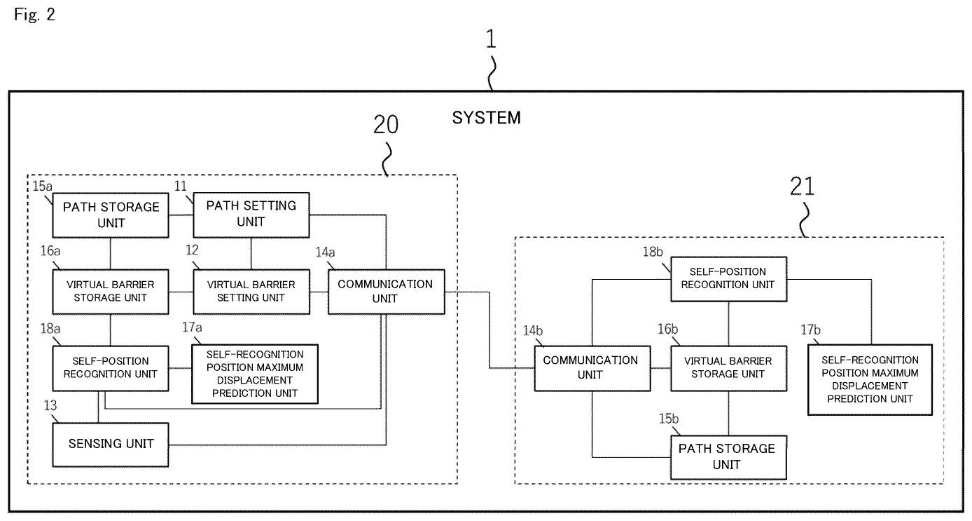

FIG. 2 is a diagram illustrating an example of a system including the mobile bodies of the first example embodiment. The configuration of the information processing apparatus 10 in the first example embodiment will be more specifically described with reference to FIG. 2.

A system 1 is a multi-agent system. The system 1 includes the leader mobile body 20 and the follower mobile bodies 21 as agents.

As illustrated in FIG. 2, in the system 1, the leader mobile body 20 is mounted with the path setting unit 11, the virtual barrier setting unit 12, the sensing unit 13, the communication unit 14a, a path storage unit 15a, a virtual barrier storage unit 16a, a self-recognition position maximum displacement prediction unit 17a, and a self-position recognition unit 18a. The follower mobile body 21 is mounted with a communication unit 14b, a path storage unit 15b, a virtual barrier storage unit 16b, a self-recognition position maximum displacement prediction unit 17b, and a self-position recognition unit 18b.

The path setting unit 11 mounted on the leader mobile body 20 sets the path of each follower mobile body 21 based on the path of the leader mobile body 20. The path of the leader mobile body 20 is transmitted to the path storage unit 15a mounted on the leader mobile body 20. The path of the follower mobile body 21 is transmitted to the path storage unit 15b mounted on the follower mobile body 21 via the communication units 14a and 14b. In other words, the communication unit 14a transmits, to the follower mobile body 21, the path of the follower mobile body 21 (alternatively, instruction information that instructs the follower mobile body 21 to move along the movement path). The communication unit 14b receives, from the leader mobile body 20, the path of the follower mobile body 21 (alternatively, the instruction information that instructs the follower mobile body 21 to move along the movement path).

The virtual barrier setting unit 12 mounted on the leader mobile body 20 sets the virtual barrier 30 of the leader mobile body 20, and transmits the virtual barrier 30 to the virtual barrier storage unit 16a mounted on the leader mobile body 20. The virtual barrier setting unit 12 sets the virtual barrier 31 of each follower mobile body 21, and transmits the virtual barrier 31 to the virtual barrier storage unit 16b mounted on the follower mobile body 21 via the communication units 14a and 14b. Alternatively, it can also be said that the communication unit 14a transmits, to the follower mobile body 21, range information (an example of the virtual barrier 32) representing a range in which the leader mobile body 20 can perform communication. It can also be said that the communication unit 14b receives, from the leader mobile body 20, the range information (an example of the virtual barrier 32) representing the range in which the leader mobile body 20 can perform communication.

The sensing unit 13 mounted on the leader mobile body 20 calculates the position of the follower mobile body 21 based on the relative coordinates of the leader mobile body 20 and the other follower mobile bodies 21, and transmits the position of the follower mobile body 21 to the self-position recognition unit 18a of the follower mobile body 21 via the communication units 14a and 14b.

The self-recognition position maximum displacement prediction unit 17a mounted on the leader mobile body 20 predicts the maximum value of the displacement between the self-recognition position and the actual self-position of the leader mobile body 20, and the self-position recognition unit 18a mounted on the leader mobile body 20 estimates the self-recognition position of the leader mobile body 20, and in a case where it is determined that there is a possibility that the leader mobile body 20 is outside the virtual barrier 30 in consideration of the maximum value of the displacement predicted by the self-recognition position maximum displacement prediction unit 17a, requests communication and updates the self-recognition position.

The self-recognition position maximum displacement prediction unit 17b mounted on the follower mobile body 21 predicts the maximum value of the displacement between the self-recognition position and the actual self-position of the follower mobile body 21, and the self-position recognition unit 18b mounted on the follower mobile body 21 estimates the self-recognition position of the follower mobile body 21, and in a case where it is determined that there is a possibility that the follower mobile body 21 is outside the virtual barrier 31 in consideration of the maximum value of the displacement predicted by the self-recognition position maximum displacement prediction unit 17b, requests communication and updates the self-recognition position.

It can also be said that the self-recognition position maximum displacement prediction unit 17b and the self-position recognition unit 18b have functions as a setting unit that sets the position of the follower mobile body 21. In this case, it can also be said that after setting the position of the follower mobile body 21 at a certain time, the setting unit determines whether the follower mobile body 21 moves outside the range (virtual barrier 31) by an error that occurs at a time elapsed since the certain time. The certain time is, for example, a time when the position is updated last time. In a case where it is determined that the follower mobile body 21 moves outside the range, the setting unit requests the leader mobile body 21 for the position, receives the position transmitted according to the request, and sets the position in the follower mobile body 21.

### [Apparatus Operation]

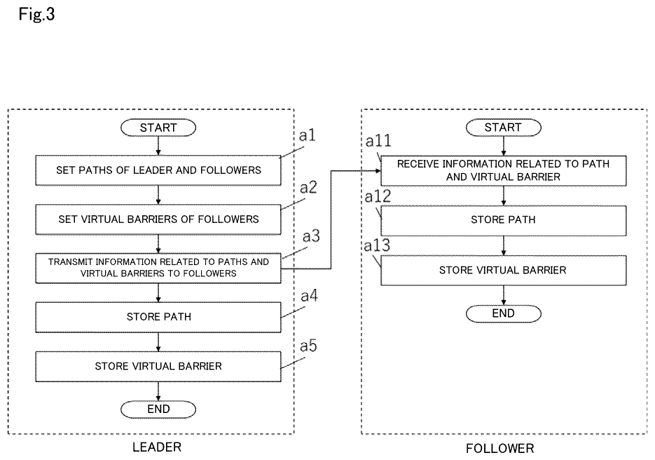

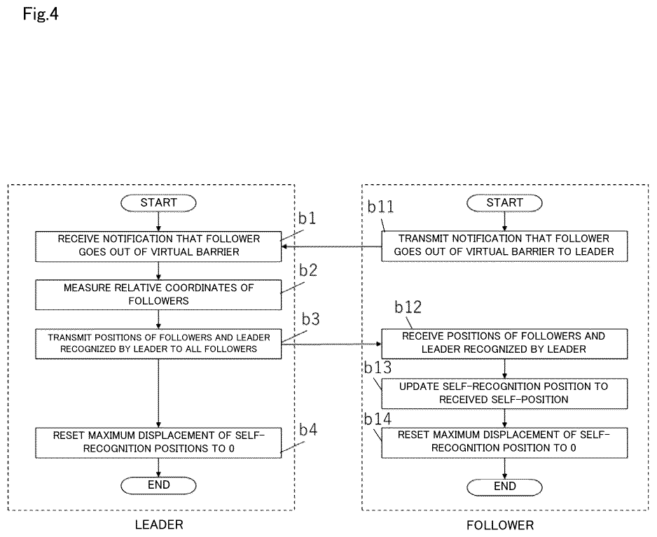

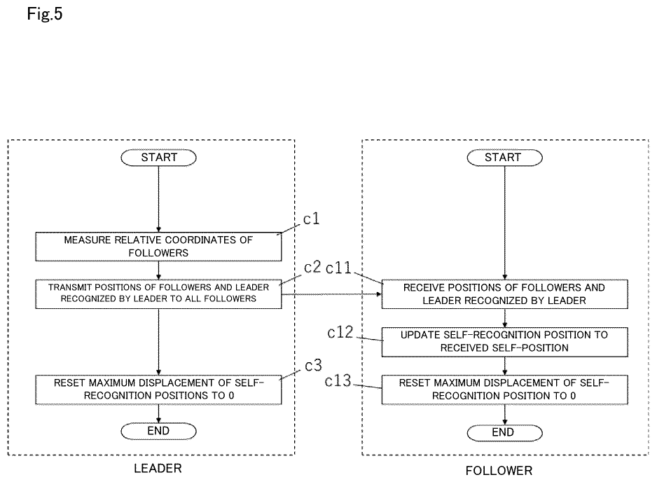

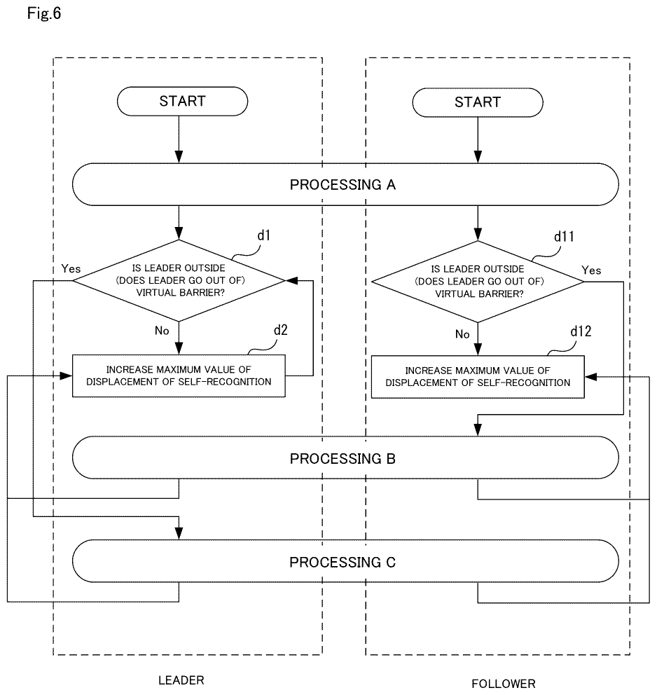

Next, operation of the information processing apparatus in the first example embodiment will be described with reference to FIGS. 3 to 6. FIGS. 3 to 6 are diagrams for describing examples of processing in the information processing apparatus in the first example embodiment, and FIG. 3 illustrates an example of processing of initial setting, FIG. 4 illustrates an example of processing in a case where the follower goes out of the virtual barrier, FIG. 5 illustrates an example of processing in a case where the leader goes out of the virtual barrier, and FIG. 6 illustrates an example of entire processing in the information processing apparatus in the first example embodiment. FIGS. 1 and 2 will be appropriately referred to in the following description. In the first example embodiment, a control method is performed by operating the information processing apparatus. Therefore, description of the control method in the example embodiment is substituted with the following description of the operation of the information processing apparatus.

As illustrated in FIG. 3, first, the path setting unit 11 sets paths of the mobile bodies 20 and 21 in a formation controlled in such a way that the leader mobile body 20 makes the follower mobile bodies 21 follow (step al).

Next, the virtual barrier setting unit 12 sets the virtual barriers 30 and 31 indicating safe regions of the mobile bodies 20 and 21 (step a2).

Next, the paths and the virtual barriers 30 and 31 of the mobile bodies 20 and 21 are transmitted to the communication units 14a and 14b (step a3), the path storage unit 15a stores the path of the leader mobile body 20 (step a4), and the virtual barrier storage unit 16a stores the virtual barrier 30 of the leader mobile body 20 (step a5).

On the other hand, the communication unit 14b receives the path and the virtual barrier 31 of the follower mobile body 21 (step all). The path storage unit 15b stores the path of the follower mobile body 21 (step a4), and the virtual barrier storage unit 16b stores the virtual barrier 31 of the follower mobile body 21 (step a5).

As illustrated in FIG. 4, in a case where the follower mobile body 21 goes out of the virtual barrier (in a case where there is a possibility of going out), the communication unit 14a transmits, to the communication unit 14b, a notification that the follower mobile body 21 goes out of the virtual barrier 30, and the communication unit 14b receives the notification that the follower mobile body 21 goes out of the virtual barrier 30 (steps b11 and b1).

Next, the sensing unit 13 measures relative coordinates of the leader mobile body 20 and the other follower mobile bodies 21 (step b2), and the communication unit 14a transmits positions of the leader mobile body 20 and the follower mobile bodies 21 recognized by the leader mobile body 20 to all the follower mobile bodies 21 (step b3). The communication unit 14b receives the positions of the leader mobile body 20 and the follower mobile bodies 21 (step b12), and the self-position recognition unit 18b updates the received position as a self-recognition position (step b13).

Next, the self-position recognition unit 18b resets maximum displacement of the self-recognition position to 0 (step b14).

The maximum displacement of the self-recognition position is reset to 0 because the positions of all the mobile bodies 20 and 21 are unified to the positions recognized by the leader mobile body 20. There is a possibility that the self-recognition position of the leader mobile body 20 is also displaced from an actual position, but since the displacement is the same in the entire formation, it is possible to ignore the displacement in collision or communication interruption in which relative positional relationships among the mobile bodies 20 and 21 constituting the formation are important, and therefore, the maximum displacement of the self-recognition position can be safely reset to 0.

As illustrated in FIG. 5, in a case where the leader mobile body 20 goes out of the virtual barrier 30 (in a case where there is a possibility of going out), the sensing unit 13 measures the relative coordinates of the leader mobile body 20 and the other follower mobile bodies 21 without the information from the communication units 14b of the follower mobile bodies 21 (step c1), and the subsequent processing (c2, c3, and c11 to c13) is similar to that in the example illustrated in FIG. 4.

It can also be said that the self-recognition position maximum displacement prediction unit 17a and the self-position recognition unit 18a have functions as a control unit that transmits the positions of the follower mobile bodies 21. In other words, after transmitting the positions measured by the sensor (sensing unit 13) to the follower mobile bodies 21 at a certain time, the control unit in the leader mobile body 20 determines whether the leader mobile body 20 moves outside a range (for example, a range in which the leader mobile body can perform communication) due to an error that occurs at a time elapsed since the certain time. The certain time is, for example, a time when the positions are transmitted to the follower mobile bodies 21 last time. In a case where it is determined that the leader mobile body 20 moves outside the range, the control unit transmits the positions of the follower mobile bodies 21 measured by the sensor to the follower mobile bodies 21.

Processing A, processing B, and processing C illustrated in FIG. 6 relate to the processing of FIGS. 3, 4, and 5. Since content of the processing A relates to the processing of FIG. 2, description thereof will be omitted.

As illustrated in FIG. 6, the self-position recognition unit 18a estimates a self-position of the leader mobile body 20, and in a case where it is determined that the leader mobile body 20 goes out of the virtual barrier 30 (in a case where there is a possibility of going out, step d1), the self-position recognition unit 18a executes the processing C, and in a case where the leader mobile body 20 is in the virtual barrier 30, the self-recognition position maximum displacement prediction unit 17a increases a maximum value of displacement of the self-recognition position over time (step d2). The self-position recognition unit 18b estimates self-positions of the follower mobile bodies 21, and in a case where it is determined that the follower mobile body 21 goes out of the virtual barrier 30 (in a case where there is a possibility of going out, step d11), the self-position recognition unit 18b executes the processing B, and in a case where the follower mobile body 21 is in the virtual barrier, the self-recognition position maximum displacement prediction unit 17a increases a maximum value of displacement of the self-recognition position over time (step d12).

In a case where one of the mobile bodies 20 and 21 has the plurality of virtual barriers 30 and 31, the processing B or the processing C is performed in a case where the mobile body goes out of any one of the virtual barriers 30 and 31.

In the above processing, the self-position of the follower mobile body 21 is corrected by the leader mobile body 20, and the positions of the other follower mobile bodies 21 and the leader mobile body 20 are transmitted to the follower mobile bodies 21. Therefore, each follower mobile body 21 can avoid collision with the other mobile bodies 20 and 21 and maintain communication with the leader mobile body 20 based on the received position information.

### First Example

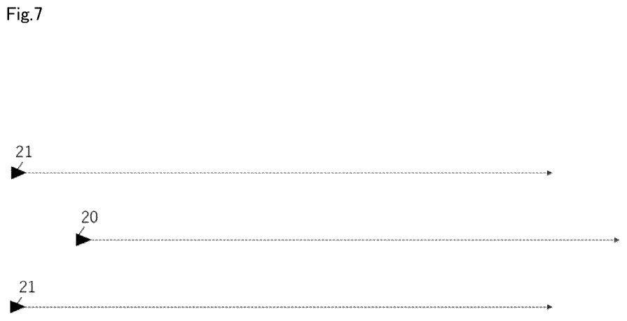

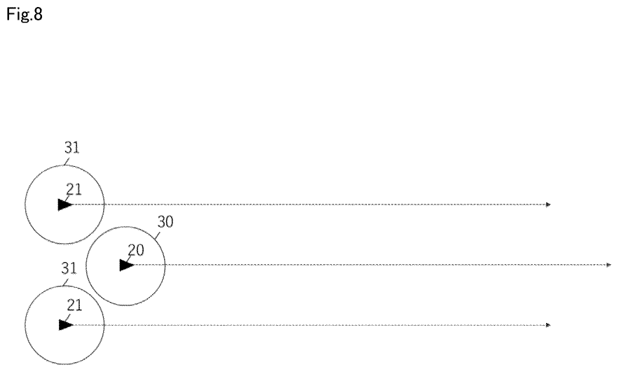

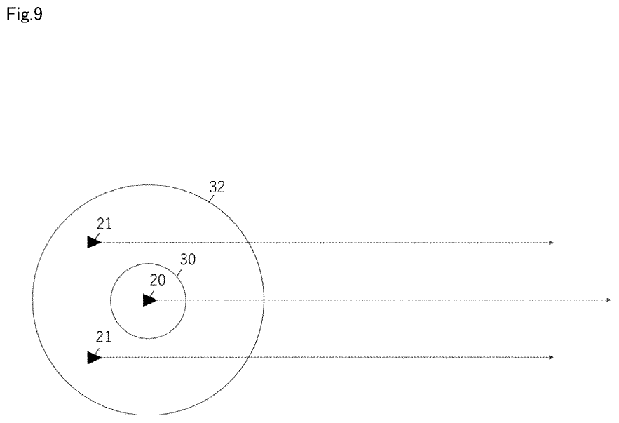

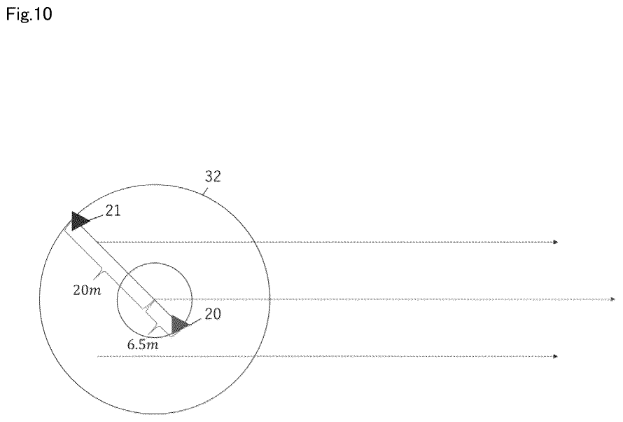

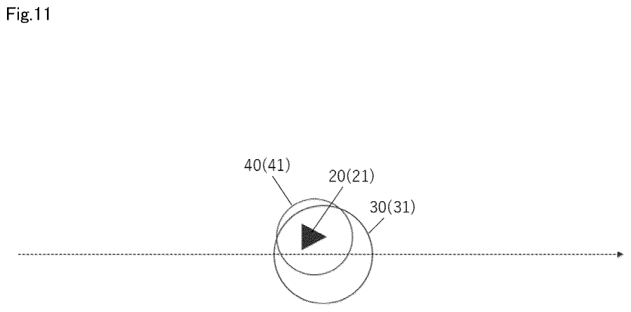

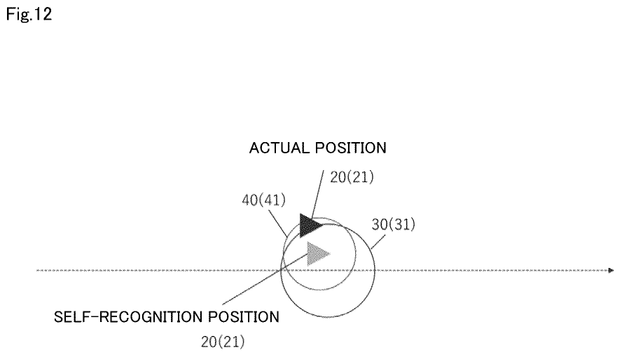

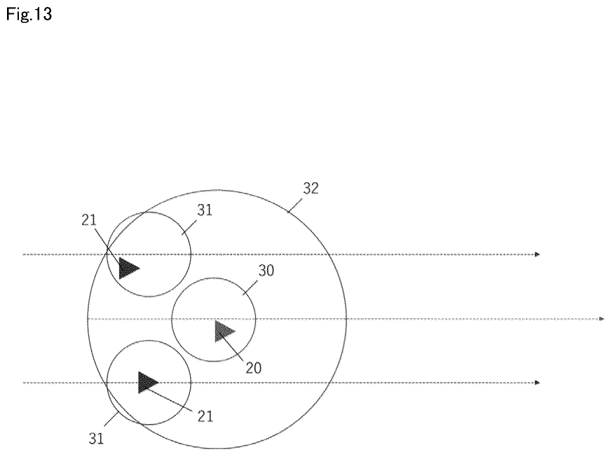

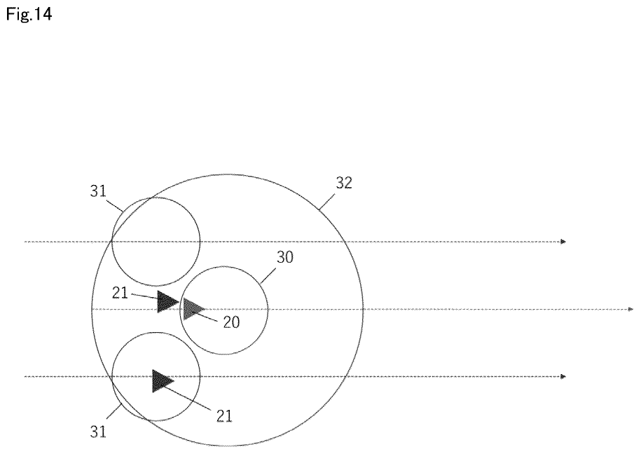

The first example embodiment will be specifically described with reference to examples. FIG. 7 is a diagram for describing an example of the paths of the leader and the followers in a first example. FIG. 8 is a diagram for describing an example of the virtual barriers of the leader and the followers in the first example. FIG. 9 is a diagram for describing an example of the virtual barrier for communication maintenance in the first example. FIG. 10 is a diagram for describing an example of the positions of the leader and the followers in the virtual barrier for communication maintenance in the first example. FIG. 11 is a diagram for describing an example of a relationship between the virtual barrier of the mobile body and positional displacement in the first example. FIG. 12 is a diagram for describing an example of a relationship between the self-recognition position and the actual position of the mobile body in the first example. FIG. 13 is a diagram for describing an example of the virtual barriers for collision prevention and the virtual barrier for communication maintenance of the leader and the followers in the first example. FIG. 14 is a diagram for describing an example of a case where the follower goes out of the virtual barrier in the first example.

In the first example, first, the path setting unit 11 sets the paths as illustrated in FIG. 7. For the sake of simplicity, in the first example, the simple straight paths are set.

The path of the leader mobile body 20 is represented by an expression: P(t)=(t, 0). That is, the path in which the leader mobile body 20 is at a position (t, 0) at the time t seconds. There are the two paths of the follower mobile bodies 21, and the path of the upper follower is P(t)=(t−10, 10), and the path of the lower follower is P(t)=(t−10, −10). That is, the paths are 10 m behind the leader and follow positions that are separated above and below from the leader by 10 m.

As illustrated in FIG. 8, the virtual barriers are set. The virtual barriers for collision avoidance 30 and 31 are set as spheres having a radius of 6.5 m and centered on the paths. FIG. 8 illustrates the virtual barriers for collision avoidance at a time 0. A minimum distance between the mobile bodies on the paths is 10×21/2, and the virtual barriers for collision avoidance 30 and 31 of the mobile bodies 20 and 21 do not have an overlapping portion at an optional time. Therefore, as long as each of the mobile bodies 20 and 21 is in the virtual barrier for collision avoidance 30 or 31, there is no risk of collision with the other mobile bodies.

As illustrated in FIGS. 9 and 10, the virtual barrier for communication maintenance 32 is set. The virtual barrier for communication maintenance 32 is the virtual barrier for communication maintenance formed around the virtual barrier for collision avoidance 30 of the leader mobile body 20 and common to the two followers. The virtual barrier for communication maintenance 32 is represented by, for example, a sphere centered on the path of the leader. In the example illustrated in FIG. 10, the virtual barrier for communication maintenance 32 is the sphere having a radius of 20 m. Assuming that a communicable distance between the leader mobile body 20 and the follower mobile body 21 is 30 m, when both the leader mobile body 20 and the follower mobile body 21 are in the virtual barrier for communication maintenance 32, as illustrated in FIG. 10, a distance between the leader mobile body 20 and the follower mobile body 21 is equal to or less than 26.5 m at the longest, and thus communication is always maintained.

The communication units 14a and 14b transmit and receive the set paths and the virtual barriers 30 and 31, the path storage units 15a and 15b store the path of the leader mobile body 20 and the paths of the follower mobile bodies 21, and the virtual barrier storage units 16a and 16b store the virtual barriers 30 and 31. After the above setting, the mobile bodies 20 and 21 form a formation and start moving.

During the movement, the self-position recognition units 18a and 18b of the mobile bodies 20 and 21 constantly determine whether there is a possibility that the mobile bodies 20 and 21 are outside (go out of) the virtual barriers 30 and 31, and when it is determined that there is the possibility, request communication. An example of the determination is illustrated in FIG. 11.

As illustrated in FIG. 11, a triangle indicating the mobile body 20 or 21 represents the self-recognition position estimated by the self-position recognition unit 18a or 18b. As illustrated in FIG. 11, while the virtual barrier 30 or 31 is the circle centered on the path, a circle (sphere) 40 or 41 having the maximum displacement predicted by the self-recognition position maximum displacement prediction unit 17a or 17b as a radius is centered on the self-recognition position. Since the radius is the maximum displacement from an actual position, the actual position of the mobile body 20 or 21 is any one of points in the circle (sphere) 40 or 41. Therefore, as illustrated in FIG. 12, there is a case where the mobile body 20 or 21 is actually outside the virtual barrier 30 or 31, and in this example, it is determined that there is a possibility that the mobile body 20 or 21 is outside (go out of) the virtual barrier 30 or 31.

In a case where the self-position recognition unit 18b mounted on the follower mobile body 21 determines that there is a possibility that the follower mobile body 21 is outside the virtual barrier 31, communication is performed from the communication unit 14b of the follower mobile body 21 to the communication unit 14a of the leader mobile body 20, the relative coordinates with the follower mobile body 21 are measured by the sensing unit 13 mounted on the leader mobile body 20, and the position of the follower mobile body 21 is calculated.

For example, it is assumed that the self-recognition position of the leader mobile body 20 is (20, −1), and the relative coordinates of the follower mobile bodies 21 measured by the sensing unit 13 are (−11, 10) and (−10, −9). At this time, the positions of the follower mobile bodies 21 recognized by the leader mobile body 20 are sums of the self-recognition position and the relative coordinates, which are (9, 9) and (10, −10).

The leader mobile body 20 transmits the positions (20, −1), (−11, 10), and (−10, −9) of the leader mobile body 20 and all the follower mobile bodies 21 to each of the follower mobile bodies 21. Then, the maximum displacement predicted by the self-recognition position maximum displacement prediction unit 17 is reset to 0. The self-position recognition unit 18b mounted on the follower mobile body 21 that has received the position information from the communication unit 14a of the leader mobile body 20 updates the self-recognition position according to the received positions, and then resets the maximum displacement predicted by the self-recognition position maximum displacement prediction unit 17b to 0.

As a result of updating the self-recognition positions, all the mobile bodies 20 and 21 are unified to the positions recognized by the leader mobile body 20, and a recognition error of the distance among the mobile bodies becomes 0. An update result of the self-recognition positions is illustrated in FIGS. 13 and 14. As illustrated in FIG. 13, in a case where the self-recognition positions of the updated mobile bodies 20 and 21 are in the virtual barriers 30 and 31, it can be seen that there is currently no risk of collision or communication interruption. On the other hand, as illustrated in FIG. 14, in a case where the self-recognition position of the mobile body 21 that is a part of the updated mobile bodies 20 and 21 is outside the virtual barrier 31, there is a risk of collision with the other mobile bodies. In such a case, since the self-recognition positions of the mobile bodies 20 and 21 are outside the virtual barriers 30 and 31, communication is continuously performed until the mobile bodies 20 and 21 return into the virtual barriers 30 and 31.

Since the positions of the other mobile bodies 20 and 21 are shared by the mobile bodies 20 and 21 as a result of the communication, the mobile bodies 20 and 21 can take actions to avoid collision based on this information. For example, in order to avoid collision with the approaching follower mobile body 21, the leader mobile body 20 can take an action such as moving forward in the virtual barrier 30.

When the follower mobile body 21 returns to the inside of the virtual barrier 31, the continuous communication is ended, and the communication is not performed until it is determined that there is a possibility that the mobile bodies 20 and 21 are outside the virtual barriers 30 and 31 again (except for a case where the path is changed).

As described above, according to the first example embodiment, it is possible to reduce a communication amount among the mobile bodies while avoiding collision and maintaining communication among the mobile bodies.

### [Program]

A program in the first example embodiment is only required to be a program that causes a computer to execute the steps illustrated in FIGS. 3 to 6. When the program is installed and executed in the computer, the information processing apparatus and the control method in the first example embodiment can be achieved. In this case, a processor of the computer functions as the path setting unit 11, the virtual barrier setting unit 12, the sensing unit 13, the communication unit 14, the path storage unit 15, the virtual barrier storage unit 16, the self-recognition position maximum displacement prediction unit 17, and the self-position recognition unit 18, and performs processing.

The program in the first example embodiment may be executed by a computer system constructed by a plurality of computers. In this case, for example, each computer may function as any one of the path setting unit 11, the virtual barrier setting unit 12, the sensing unit 13, the communication unit 14, the path storage unit 15, the virtual barrier storage unit 16, the self-recognition position maximum displacement prediction unit 17, and the self-position recognition unit 18.

### [Physical Configuration]

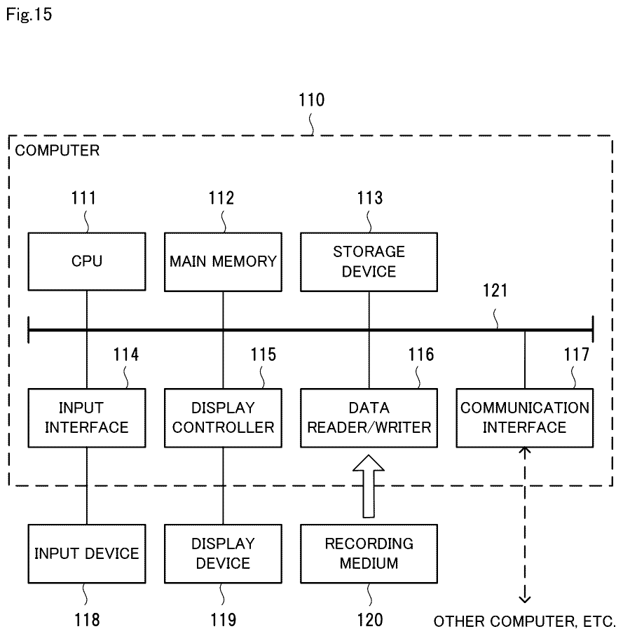

Here, a computer that achieves the information processing apparatus 10 by executing the program in the first example embodiment will be described with reference to FIG. 15. FIG. 15 is a block diagram illustrating an example of the computer that achieves the information processing apparatus 10 in the first example embodiment.

As illustrated in FIG. 15, a computer 110 includes a central processing unit (CPU) 111, a main memory 112, a storage device 113, an input interface 114, a display controller 115, a data reader/writer 116, and a communication interface 117. These units are connected via a bus 121 to be able to perform data communication with each other.

The computer 110 may include a graphics processing unit (GPU) or a field-programmable gate array (FPGA) in addition to the CPU 111 or instead of the CPU 111. In this aspect, the GPU or the FPGA can execute the program in the example embodiment.

The CPU 111 develops the program in the example embodiment, which is stored in the storage device 113 and configured by codes, in the main memory 112, and executes each code in a predetermined order to perform various operations. The main memory 112 is typically a volatile storage device such as a dynamic random access memory (DRAM).

The program in the example embodiment is provided in a state of being stored in a computer-readable recording medium 120. The program in the present example embodiment may be distributed on the Internet connected via the communication interface 117.

Specific examples of the storage device 113 include a semiconductor storage device such as a flash memory in addition to a hard disk drive. The input interface 114 mediates data transmission between the CPU 111 and an input device 118 such as a keyboard and a mouse. The display controller 115 is connected to a display device 119 and controls display on the display device 119.

The data reader/writer 116 mediates data transmission between the CPU 111 and the recording medium 120, and reads a program from the recording medium 120 and writes a processing result in the computer 110 to the recording medium 120. The communication interface 117 mediates data transmission between the CPU 111 and another computer.

Specific examples of the recording medium 120 include general-purpose semiconductor storage devices such as a Compact Flash (CF) (registered trademark) and a secure digital (SD), a magnetic recording medium such as a flexible disk, and an optical recording medium such as a compact disk read only memory (CD-ROM).

The information processing apparatus 10 in the example embodiment can also be achieved using hardware related to each unit, for example, an electronic circuit, instead of the computer in which the program is installed. A part of the information processing apparatus 10 may be achieved by a program, and the remaining portion may be achieved by hardware. In the example embodiment, the computer is not limited to the computer illustrated in FIG. 9.

Some or all of the above-described example embodiment can be expressed by (Supplementary Note 1) to (Supplementary Note 11) described below, but are not limited to the following description.

### Supplementary Note 1

An information processing apparatus including:
a path setting means for setting a path of each mobile body in a formation controlled in such a way that a leader mobile body makes a follower mobile body follow;
a virtual barrier setting means for setting virtual barriers indicating safe regions of the mobile bodies;
a sensing means for measuring relative coordinates with the another mobile body and calculating a position of the follower mobile body recognized by the leader mobile body;
a communication means for transmitting and receiving, according to a request, the paths and the virtual barriers, or further positions of the mobile bodies;
a path storage means for storing the set paths;
a virtual barrier storage means for storing the set virtual barriers;
a self-recognition position maximum displacement prediction means for predicting a maximum value of displacement between a self-recognition position and an actual position; and
a self-position recognition means for estimating the self-recognition position, requesting communication in a case where it is determined that there is a possibility that the mobile body is outside the virtual barrier in consideration of the maximum value of the displacement, and updating the self-recognition position.

### Supplementary Note 2

The information processing apparatus according to Supplementary Note 1, in which
the self-recognition position maximum displacement prediction means resets the displacement to 0 after a timing at which the self-recognition position is updated and a timing at which the position of the follower mobile body is calculated.

### Supplementary Note 3

The information processing apparatus according to Supplementary Note 1, in which
the self-position recognition means updates the self-recognition position when the leader mobile body receives a self-position.

### Supplementary Note 4

A control method by a computer, the control method including:
setting a path of each mobile body in a formation controlled in such a way that a leader mobile body makes a follower mobile body follow;
setting virtual barriers indicating safe regions of the mobile bodies;
measuring relative coordinates with the another mobile body and calculating a position of the follower mobile body recognized by the leader mobile body;
transmitting and receiving, according to a request, the paths and the virtual barriers, or further positions of the mobile bodies;
storing the set paths;
storing the set virtual barriers;
predicting a maximum value of displacement between a self-recognition position and an actual position; and
estimating the self-recognition position, requesting communication in a case where it is determined that there is a possibility that the mobile body is outside the virtual barrier in consideration of the maximum value of the displacement, and updating the self-recognition position.

### Supplementary Note 5

The control method according to Supplementary Note 4, in which
the displacement is reset to 0 after a timing at which the self-recognition position is updated and a timing at which the position of the follower mobile body is calculated.

### Supplementary Note 6

The control method according to Supplementary Note 4, in which
the self-recognition position is updated when the leader mobile body receives a self-position.

### Supplementary Note 7

A computer-readable recording medium recording a program including an instruction for causing a computer to:
set a path of each mobile body in a formation controlled in such a way that a leader mobile body makes a follower mobile body follow;
set virtual barriers indicating safe regions of the mobile bodies;
measure relative coordinates with the another mobile body and calculate a position of the follower mobile body recognized by the leader mobile body;
transmit and receive, according to a request, the paths and the virtual barriers, or further positions of the mobile bodies;
store the set paths;
store the set virtual barriers;
predict a maximum value of displacement between a self-recognition position and an actual position; and
estimate the self-recognition position, request communication in a case where it is determined that there is a possibility that the mobile body is outside the virtual barrier in consideration of the maximum value of the displacement, and update the self-recognition position.

### Supplementary Note 8

The computer-readable recording medium according to Supplementary Note 7, for further causing the computer to
reset the displacement to 0 after a timing at which the self-recognition position is updated and a timing at which the position of the follower mobile body is calculated.

### Supplementary Note 9

The computer-readable recording medium according to Supplementary Note 7, for further causing the computer to
update the self-recognition position when the leader mobile body receives a self-position.

### Supplementary Note 10

A control apparatus including:
a sensor that measures a position of a follower mobile body;
a communication means for transmitting, to the follower mobile body, range information representing a range in which a leader mobile body is capable of performing communication and instruction information instructing movement along a movement path; and
control means for transmitting the position measured by the sensor to the follower mobile body in a case where it is determined that the leader mobile body moves outside the range based on an error that occurs at a time elapsed since a certain time after the position measured by the sensor is transmitted to the follower mobile body at the certain time.

### Supplementary Note 11

A control apparatus including:
control means for receiving, from a leader mobile body, range information representing a range in which the leader mobile body is capable of performing communication and instruction information instructing movement along a movement path, and controlling an operation according to the received information; and
setting means for requesting, in a case where it is determined that a follower mobile body moves outside the range based on an error that occurs at a time elapsed since a certain time after a position of the follower mobile body is set at the certain time, the leader mobile body for the position, and setting the received position according to the request.

While the present invention has been particularly shown and described with reference to example embodiments thereof, the present invention is not limited to these example embodiments. It will be understood by those of ordinary skill in the art that various changes in form and details may be made therein without departing from the spirit and scope of the present invention as defined by the claims.

### INDUSTRIAL APPLICABILITY

As described above, according to the present disclosure, it is possible to plan a path along which a follower can follow a leader.

### REFERENCE SIGNS LIST

10 information processing apparatus
11 path setting unit
12 virtual barrier setting unit
13 sensing unit
14, 14a, 14b communication unit
15, 15a, 15b path storage unit
16, 16a, 16b virtual barrier storage unit
17, 17a, 17b self-recognition position maximum displacement prediction unit
18, 18a, 18b self-position recognition unit
20 leader mobile body
21 follower mobile body
30, 31 virtual barrier (for collision prevention)
32 virtual barrier (for communication maintenance)
40 circle (sphere) having maximum displacement as radius
110 computer
111 CPU
112 main memory
113 storage device
114 input interface
115 display controller
116 data reader/writer
117 communication interface
118 input device
119 display device
120 recording medium
121 bus

What is claimed is:

1. An information processing apparatus comprising:
at least one memory storing instructions; and
at least one processor configured to execute the instructions to:
set a path of each mobile body in a formation controlled in such a way that a leader mobile body makes a follower mobile body follow;
set virtual barriers indicating safe regions of the mobile bodies;
measure relative coordinates with the another mobile body and calculating a position of the follower mobile body recognized by the leader mobile body;
transmit and receive, according to a request, the paths and the virtual barriers, or further positions of the mobile bodies;
store set paths;
store the set virtual barriers;
predict a maximum value of displacement between a self-recognition position and an actual position; and
estimate self-recognition position, requesting communication in a case where it is determined that there is a possibility that the mobile body is outside the virtual barrier in consideration of the maximum value of the displacement, and update the self-recognition position.

2. The information processing apparatus according to claim 1, wherein
the one or more processors further:
resets the displacement to 0 after a timing at which the self-recognition position is updated and a timing at which the position of the follower mobile body is calculated.

3. The information processing apparatus according to claim 1, wherein
the one or more processors further:
updates the self-recognition position when the leader mobile body receives a self-position.

4. A control method by a computer, the control method comprising:
setting a path of each mobile body in a formation controlled in such a way that a leader mobile body makes a follower mobile body follow;
setting virtual barriers indicating safe regions of the mobile bodies;
measuring relative coordinates with the another mobile body and calculating a position of the follower mobile body recognized by the leader mobile body;
transmitting and receiving, according to a request, the paths and the virtual barriers, or further positions of the mobile bodies;
storing the set paths;
storing the set virtual barriers;
predicting a maximum value of displacement between a self-recognition position and an actual position; and
estimating the self-recognition position, requesting communication in a case where it is determined that there is a possibility that the mobile body is outside the virtual barrier in consideration of the maximum value of the displacement, and updating the self-recognition position.

5. The control method according to claim 4, wherein
the displacement is reset to 0 after a timing at which the self-recognition position is updated and a timing at which the position of the follower mobile body is calculated.

6. The control method according to claim 4, wherein
the self-recognition position is updated when the leader mobile body receives a self-position.

7. A non-transitory computer-readable recording medium recording a program including an instruction for causing a computer to:
set a path of each mobile body in a formation controlled in such a way that a leader mobile body makes a follower mobile body follow;
set virtual barriers indicating safe regions of the mobile bodies;
measure relative coordinates with the another mobile body and calculate a position of the follower mobile body recognized by the leader mobile body;
transmit and receive, according to a request, the paths and the virtual barriers, or further positions of the mobile bodies;
store the set paths;
store the set virtual barriers;
predict a maximum value of displacement between a self-recognition position and an actual position; and
estimate the self-recognition position, request communication in a case where it is determined that there is a possibility that the mobile body is outside the virtual barrier in consideration of the maximum value of the displacement, and update the self-recognition position.

8. The non-transitory computer-readable recording medium according to claim 7, for further causing the computer to
reset the displacement to 0 after a timing at which the self-recognition position is updated and a timing at which the position of the follower mobile body is calculated.

9. The non-transitory computer-readable recording medium according to claim 7, for further causing the computer to
update the self-recognition position when the leader mobile body receives a self-position.

10.-11. (canceled)
